(19) United States
(12) Patent Application Publication
(10) Pub. No.: US 2013/0085781 A1
(43) Pub. Date: Apr. 4, 2013

(54) SYSTEMS AND METHODS FOR GENERATING AND UPDATING ELECTRONIC MEDICAL RECORDS

(71) Applicant: ECLINICALWORKS, LLC, Westborough, MA (US)

(72) Inventors: Girish K. Navani, Shrewsbury, MA (US); Sapankumar H. Parikh, Surat (IN); Saurabh R. Singh, Newtown, MA (US)

(73) Assignee: ECLINICALWORKS, LLC, Westborough, MA (US)

(21) Appl. No.: 13/633,069

(22) Filed: Oct. 1, 2012

Related U.S. Application Data
(60) Provisional application No. 61/626,604, filed on Sep. 29, 2011.
(60) Provisional application No. 61/639,636, filed on Apr. 27, 2012.

(51) Int. Cl. G06Q 50/24

(52) U.S. Cl. 705/3

(57) ABSTRACT

Systems and methods are disclosed for creating and updating medical records and documents. A user input is received in a first section on an interface comprising unstructured textual data that is associated with a medical record. The user input received in the first section may be utilized to update the medical record preferably without requiring the user to provide an additional second input in a separate section. At least a portion of the unstructured textual data is mapped to one or more attributes associated with a structured format for the medical record. In response to receiving a single data transfer command, an instruction is generated causing a transfer of the unstructured textual data to a second section on the interface associated with the structured format for the medical record. The mapped data is displayed in the second section in accordance with the structured format.

### CROSS-REFERENCE TO RELATED APPLICATIONS

The present application claims priority to U.S. Provisional Patent Application No. 61/626,604 filed on Sep. 29, 2011 and U.S. Provisional Patent Application No. 61/639,636 filed on Apr. 27, 2012, both of which are incorporated herein by reference in their entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present principles are directed to systems and methods for providing medical services, and more particularly, to providing a streamlined medical service that expedites document preparation, document updates and task execution using a simplified, user-friendly interface.

### BACKGROUND OF THE INVENTION

The medical industry is currently going through a transition period which involves switching to an electronic medical record (EMR) system. The transition requires medical practitioners, or personnel working for at medical facility, to operate and utilize medical software as part of their practice. The software is typically provided by a third-party EMR vendor. While medical practitioners can utilize the software to perform a variety of different tasks, the software currently available to practitioners is inadequate for several reasons.

One problem associated with the current software provided by EMR vendors relates to the fact that operation of the software is difficult and time-consuming. This is attributable, at least in part, to the interfaces associated with the software, which typically require a medical practitioner to navigate through a series of different screens and/or pop-up windows in order to perform a single task (e.g., generating a document, updating portions of a progress note, faxing a prescription, etc). For example, a practitioner is required to move from one tab or input field to another, close a window, open another window, and repeat this process multiple times. Consequently, a practitioner operating the software is faced with a large learning curve given that the practitioner must have detailed knowledge and extensive experience with the software in order to operate the software effectively. Furthermore, even when the practitioners finally learn how to operate the software, utilizing the software to complete a task is still overly time-consuming and tedious.

Another problem associated with software currently available to medical practitioners is that the software does not allow users to generate or update medical documents and records (e.g., such as patient progress notes) in a simplified manner. This deficiency stems from the fact that the software functionality for handling such records does not include any underlying “intelligence”. For example, the software is unable to make inferences or deductions based on available data (e.g., data which has been input by the medical practitioner during the generation of a document which includes the patient's medical information; data from similar documents generated by other medical practitioners; data from an aggregate pool of EMR records, etc.), and does not implement learning or training mechanisms that may assist practitioners with the generation of documents.

Therefore, there is a need for a streamlined electronic medical service that is user-friendly and intelligent, and which can be utilized by medical practitioners to efficiently generate electronic medical documents and update patient records.

### SUMMARY OF THE INVENTION

The disclosure provided herein details a number of inventive aspects associated with providing a medical service to a users, such as medical practitioners or persons employed at a medical facility. Amongst other things, a medical service is disclosed for generating and updating medical documents and records in a manner that significantly reduces the amount of time and effort required to perform such tasks, making the tasks user-friendly and enhancing the practitioners' experience with the EMR software, along with making data completely reportable. A user may provide some basic input and the system has the ability to intelligently generate a document using various sources of information (e.g., input provided by the user, data from the patient's medical history, an aggregate pool comprising data from a plurality of patients, etc.).

The interface is designed in a manner that is simple to use and that makes the functionality of the system, as well as the particular manner of operating the system, transparent to the user. Contrary to many related products that are currently available, the interface is not cluttered and the user is not required to navigate through a series of interfaces in order to generate and update a document. Rather, in some embodiments, the interface is configured to include two primary sections (e.g., input areas). The user may input all of the data into one of the sections of the screen and then through the activatation of a data transfer trigger, input from the first section is used to populate the second section according to a structured format associated with the document. This enables a user to quickly and easily create a document with a single click of a button after the user has provided the input. It should be noted that when reference is made herein to the generation of a document, it should be understood to encompass the creation or updating of any electronic document or record, including ones in which medical information relevant to a patient or healthcare practitioner is maintained, such as program notes.

Other advantageous features described herein relate to collections of “actions” that may be performed to assist the user with various tasks related to the administration of a medical practice. Some of these exemplary actions or tasks may include transmitting a prescription to pharmacy, importing history data associated with a patient, sending a facsimile transmission (e.g., to a provider or insurance company), verifying data in a patient's electronic medical records or profile, displaying a listing of order sets that may be selected by a user, displaying a list of templates that would likely be useful to the user, and performing operations (e.g., reporting operations) on an aggregated set of mapped data associated with a plurality of patients.

In accordance with the present principles, a method is disclosed for providing a medical service. A user input is received in a first section on an interface comprising unstructured textual data that is associated with an electronic medical record. The user input received in the first section may be utilized to update the electronic medical record without requiring the user to provide an additional second input in a separate section. At least a portion of the unstructured textual data is mapped to one or more attributes associated with a structured format of the electronic medical record. In response to receiving a single data transfer command, an instruction is generated causing a transfer of the unstructured textual data to a second section on the interface associated with the structured format for the electronic medical record. The mapped data is displayed in the second section in accordance with the structured format.

In accordance with the present principles, a system is disclosed for providing a medical service. A first section on an interface is configured to receive a user input comprising unstructured textual data that is associated with an electronic medical record. The user input received in the first section may be utilized to update the electronic medical record without requiring the user to provide an additional second input in a separate section. A second section includes a structured format associated with the electronic medical document. A document generator is configured to map at least a portion of the unstructured textual data to one or more attributes associated with the structured format in the second section. A data transfer button is configured to generate an instruction causing a transfer of the unstructured textual data to the second section in accordance with the structured format.

These and other features and advantages will become apparent from the following detailed description of illustrative embodiments thereof, which is to be read in connection with the accompanying drawings.

### BRIEF DESCRIPTION OF DRAWINGS

The inventive principles are illustrated in the figures of the accompanying drawings which are meant to be exemplary and not limiting, in which like references are intended to refer to like or corresponding parts, and in which:

FIG. 1 is a block diagram of a system for providing electronic medical services in accordance with certain embodiments of the present invention.

FIG. 2 illustrates a detailed view of a server configured to provide medical services in accordance with certain embodiments of the present invention.

FIG. 3A illustrates a client interface in communication with a medical server in accordance with certain embodiments of the present invention.

FIG. 3B illustrates a second client interface in communication with a medical server in accordance with certain embodiments of the present invention.

FIG. 3C illustrates a third client interface in communication with a medical server in accordance with certain embodiments of the present invention.

FIG. 3D illustrates a fourth client interface in communication with a medical server in accordance with certain embodiments of the present invention.

FIG. 4 is a flow chart of a method for generating a structured medical document in accordance with certain embodiments of the present invention.

FIG. 5 is a flow chart of a method for mapping context-insensitive information in accordance with certain embodiments of the present invention.

FIG. 6 is a flow chart of a method for generating a suggestion list in accordance with certain embodiments of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

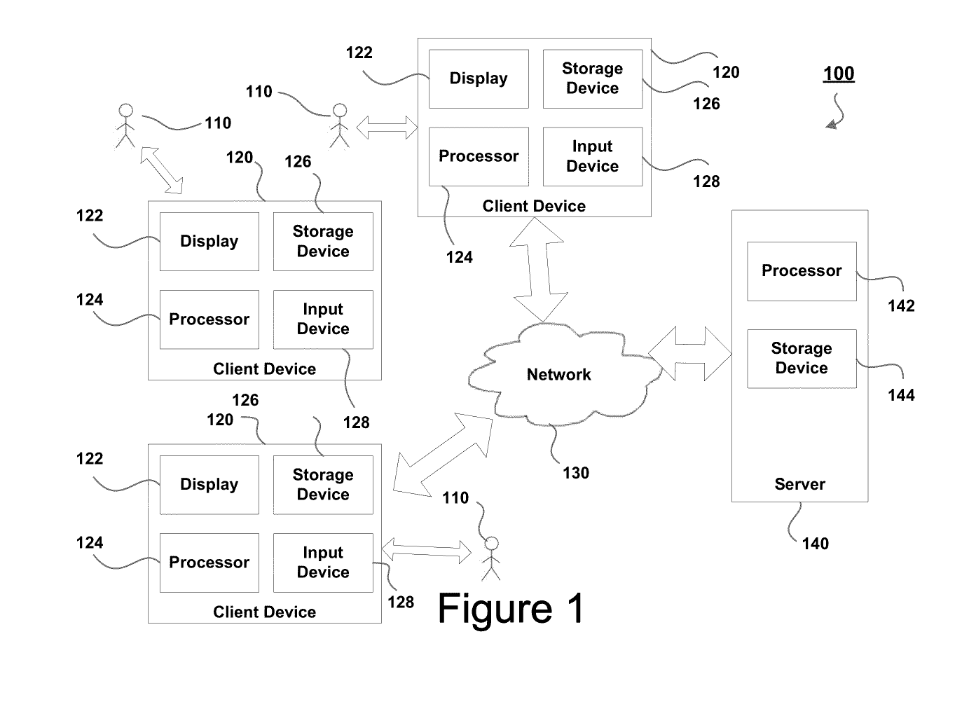

Referring now to the drawings in which like numerals represent the same or similar elements and initially to FIG. 1, a system 100 is disclosed for providing an electronic medical service. As shown therein, a plurality of client devices 120 are in communication with one or more servers 140 over a network 130. The network may be any type of network such as one that includes the Internet, a local area network, a wide area network, an intranet, etc. The users 110 may be medical practitioners, personnel working at a medical facility, or any other person. The users 110 may utilize the client devices 120 to communicate with the server 140. The client devices 120, as well as the server 140, may be configured to communicate via wired or wireless links, or a combination of the two.

The client devices 120 may represent a desktop computer, laptop computer, cell phone, tablet device, or other type of computing device. Each of the client devices 120 may be equipped with one or more computer storage devices 126 (e.g., RAM, ROM, PROM, SRAM, etc.) and one or more processing devices 124 (e.g., a central processing unit) that are capable of executing computer program instructions. Computer storage device 126 is preferably a physical, non-transitory medium. Any of the client devices 120 may further include a display 122 that is capable of rendering an interface and one or more input devices 128 (e.g., keyboard, microphone, camera, video camera, scanner, joystick, remote control device, etc.). Users 110 may manipulate interfaces rendered on the display 122 using the input devices 128 to communicate with the server 140.

The server 140 may also include one or more processors 142 and one or more computer storage devices 144. Computer storage device 144 is preferably a physical, non-transitory medium. The server 140 may generally represent any type of computing device that is capable of communicating with a client device 120. In some embodiments, the server 140 comprises one or more mainframe computing devices that execute a web server for communicating with client devices 120 over the Internet. The storage medium on the server 140 can store applications or software code that is configured to provide assistance to users 110 in performing tasks related to the practice of medicine. Specifically, the server 140 may be configured to provide medical services to users 110 via an interface displayed on the client devices 140.

For example, the server 140 may cooperate with a client device 120 to generate electronic medical documents, such as progress notes. In general, a progress note is a document drafted by a medical practitioner that describes a patient's medical condition or an encounter with a patient. A progress note is typically drafted during or after a physician-patient encounter. Since the generation or updating of a progress note or other medical document can be tedious and time-consuming, the interface and server 140 provide a expedited means for generating these documents in a user-friendly manner which requires little or no prior experience using the software. This novel process for generating and/or updating electronic medical documents, which is described in further detail below, is facilitated by a unique presentation of elements on the interface and intelligent processing of data by the server 120.

Another useful function performed by the server 120 relates to the server's 140 ability to transmit suggestions to the users 110 (e.g., suggestions which recommend a list assessments or prescriptions) for display on the interface. In certain embodiments, the suggestions provided by the server 120 may be utilized during the generation of the electronic medical documents, e.g., during the creation and/or updating of a progress note. For example, the server 120 may provide suggestions for diagnosing or assessing a patient's illness or condition, suggestions for recommending drugs that should be prescribed to a patient, or other types of suggestions.

As will be described in further detail below, these suggestions may be derived from intelligently processing the data input by the user 110 in generating the medical document (e.g., a suggested diagnosis may be based on the symptoms inputted by the practitioner), or data included in an aggregate pool of patient data stored on the server 140 (e.g., a drug may be suggested if a high percentage of patients having a similar illness have been prescribed the drug), or a combination of the two.

The server 140 may be further configured to streamline the execution of complex medical functions or actions. Some of the medical functions include generating and transmitting prescriptions to pharmacies, faxing information to medical providers and insurance companies, verifying information in a patient's medical record, importing a patient's history into a progress note or other medical document, and verifying information in a patent's medical record. Along with executing medical functions, the server may also suggest information to medical practitioner. Examples of these suggestions may include but are not limited to suggesting diagnosis, treatment and ordering information. To accomplish these functions in an expedited and user-friendly manner, the server 140 may be retrieve an underlying set of rules associated with a selected medical function and execute the function in a manner which masks the intricacies of applying rules from the user 110. Additional details regarding the medical services provided by the server 120 are described in further detail below.

It should be noted that the system in FIG. 1 is merely meant to demonstrate an embodiment of an operating environment that can be utilized in conjunction with the present taught herein, and should not be construed as limiting in any manner whatsoever. The particular configuration in FIG. 1 can be altered in numerous ways without departing from the principles herein. For example, it should be noted that the functionality of the server 140 in FIG. 1 may be carried out by a plurality of servers 140. Likewise, although the figure depicts a single server 140 connected to three client devices 120, any number of servers 140 and client devices 120 may be utilized with the system 100 and the system 100 may be configured in a variety of different ways (e.g., in a distributed computing environment, cloud-based environment, client-server environment, etc.).

Furthermore, while FIG. 1 illustrates a plurality of client devices 120 in communication with a server 140 over a network 130, it should be recognized that the functionality provided by the server 140 to the client devices 120 may be performed locally on each of the client devices 120. For example, the client devices 120 may utilize an application and/or server that executes locally on the client devices 120 to perform the functions of the server 140. Thus, any functionality of the server 140 which is described herein can alternatively be implemented by a client device 120, and vice versa.

Embodiments described herein may be hardware-based, software-based and preferably comprise a mixture of both hardware and software elements. Thus, while the description herein may describe certain embodiments, features or components as being implemented in software or hardware, it should be recognized that any embodiment, feature or component that is described in the figures or description of the present application may be implemented in hardware and/or software. In certain embodiments, particular aspects are implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

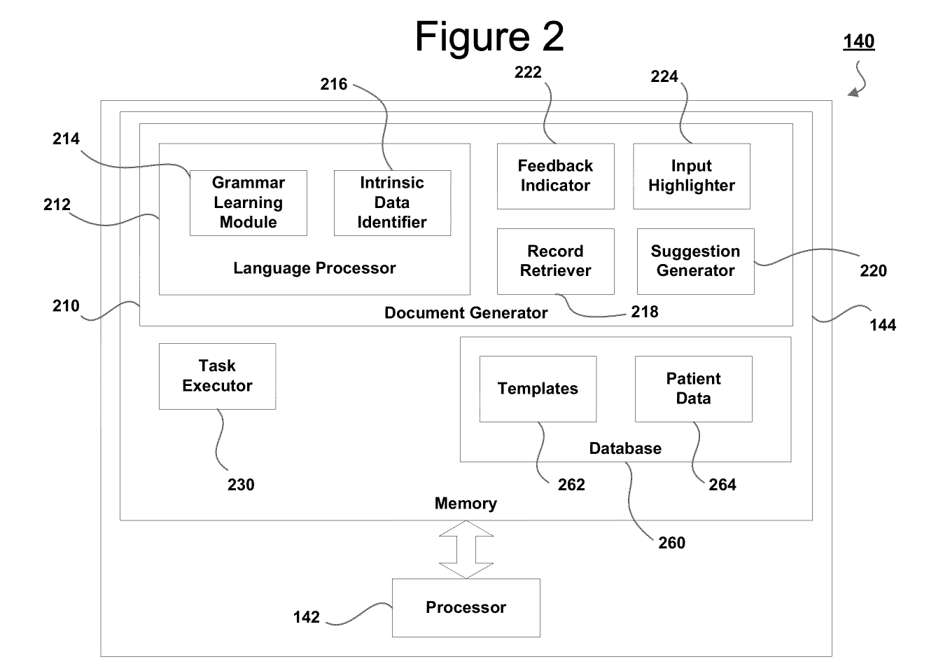

Moving on to FIG. 2, a detailed view of the server 140 illustrated in FIG. 1 is disclosed in accordance with certain embodiment of the present invention. As shown therein, the server 140 includes a plurality of software components (e.g., document generator 210, suggestion generator 220, etc.) stored on a memory device 144 (e.g., RAM, ROM, PROM, SRAM, etc). The memory device 144 is in communication with one or more processors 142 that may be configured to execute the instructions associated with software components.

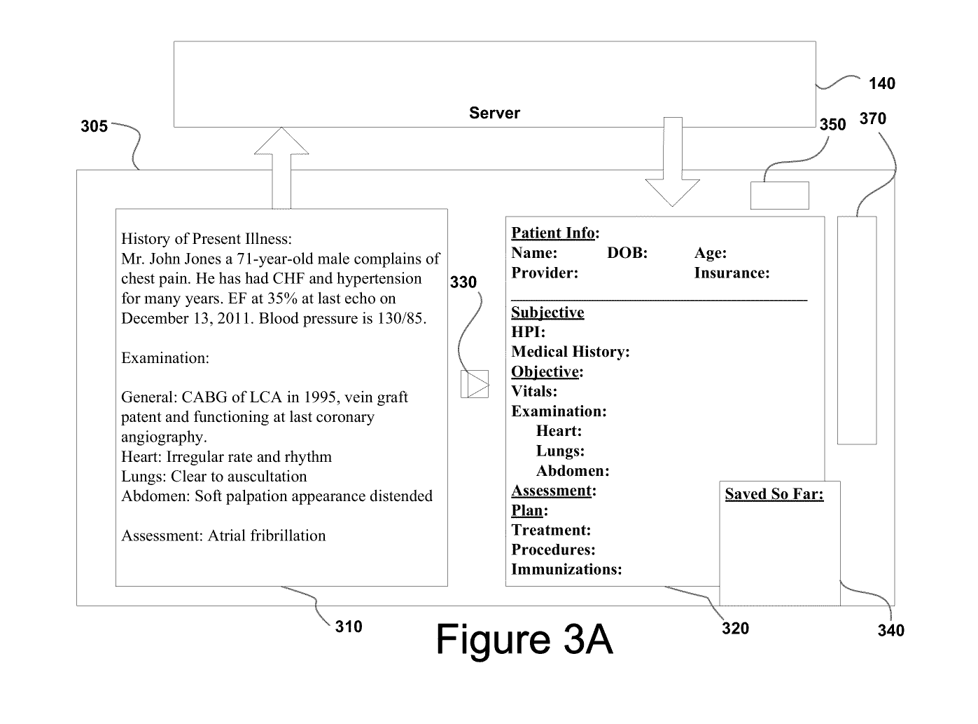

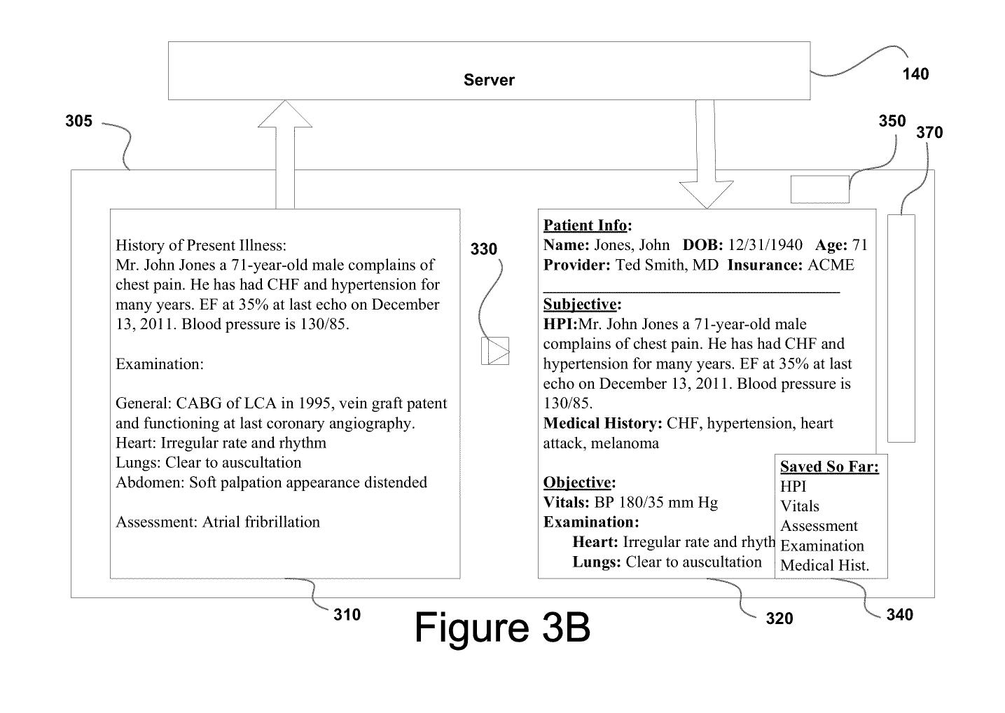

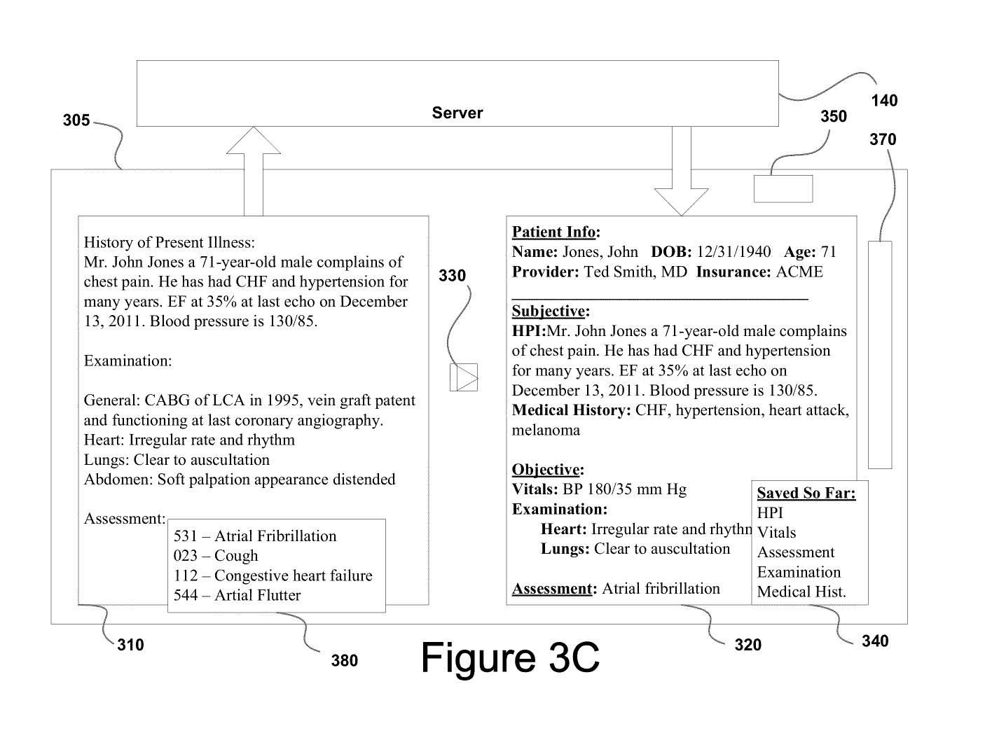

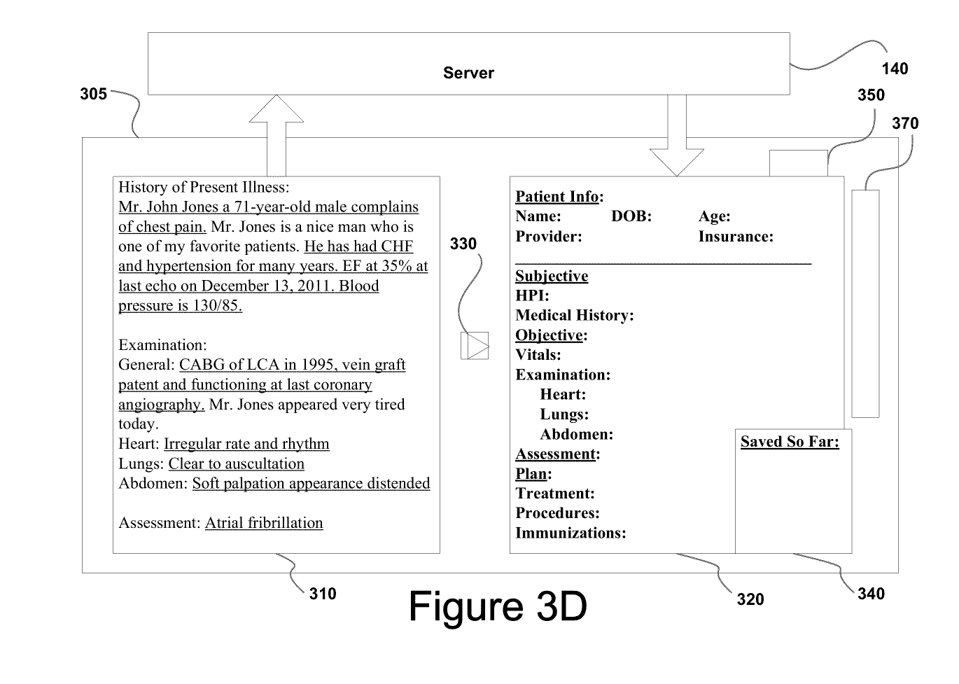

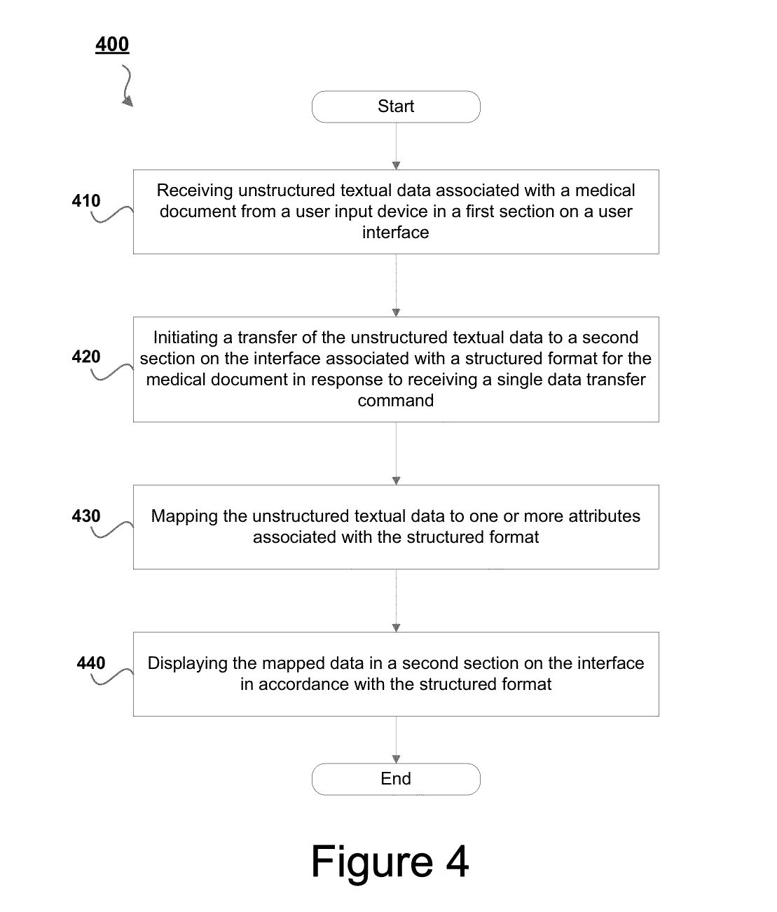

It should be noted that although the components on the memory device 144 may be described throughout this disclosure as software modules, such is not necessary. Furthermore, while the components may be illustrated as separate and distinct components, it should be recognized the components can be combined in any manner (e.g., all of the components may be executed as a part of a single program or as separately executing processes or threads) and that the functions performed by these components may overlap in some instances. In order to demonstrate the functionality performed by these components, reference will be made to FIGS. 3A-3D, which disclose exemplary interfaces for providing medical services to a user 110, as well as FIGS. 4-6, which demonstrate exemplary methods that may implemented by the server components.

The document generator 210 may be configured to generate a variety of different electronic medical documents. While the disclosure herein primarily describes an example where the document generator 210 is utilized to create and/or update a progress note, one of ordinary skill in the art would recognize that the same or similar principles can be applied to create other types electronic medical documents as well. For example, in certain embodiments, the document generator may be configured to generate documents associated with prescription or medication forms, billing documents, test results, immunization forms, profiles for a patient (e.g., which include demographic, insurance, and billing information), documents associated with test results, and other types of medical documents.

In certain embodiments, the document generator 210 may include several different sub-components including a language processor 212, grammar learning module 214, intrinsic data identifier 216, a record retriever 218, a suggestion generator 220, a feedback indicator 222 and an input highlighter 224. These sub-components may be configured to perform various functions to assist the document generator 210 in converting natural language data to structured data creating electronic medical documents as explained in further detail below.

The language processor 212 may be configured to convert unprocessed textual data or natural language data that has been input by a user 110 into a structured format associated with a medical document. For instance, suppose a user 110, such as a medical doctor, wishes to create a progress note that is to be incorporated into a patient's electronic medical records (EMRs). To accomplish this, the user 110 may initially input data that is to be incorporated into the progress note via an input device 128 (e.g., microphone, keyboard, mouse, still camera, video camera, scanner, etc.) associated with the client device 110. In certain embodiments, the input provided by the user 110 is dictated by the user, recorded by a microphone input device 110, and then subsequently converted to text (e.g., using speech recognition software). At this point, the language processor 212 may be sent (or may retrieve) the unstructured textual data from the client device 120, determine how to map the data to various attributes associated with the structure of the progress note, and transmit the determined mapping information (or the actual progress note itself that incorporates the mapping information) back to the client device 110 in order to generate and display an electronic progress note for the user 110.

To demonstrate how the language processor 212 can process data inputted by a user 110 to generate an electronic medical document, consider the exemplary interface 305 for creating a progress note that is disclosed in FIG. 3A. The interface 305 has two primary sections: input data window 310 and progress note window 320. Also, notice that a data transfer button 330 is located in between the two windows. In certain embodiments, the sections may represent input windows (e.g., input data window 310 and progress note window 320), elements associated with an HTML form (e.g., the input element defined by the HTML textarea tag), elements that are rendered using Flash, other types of areas that can be rendered on an interface 305, or any combination of the same.

When a user 110 initially inputs data relating to the progress note, the data is displayed in the input data window 310. For example, if the user 100 is dictating a progress note into a microphone input device 128, a speech recognition application may be utilized to transcribe the user's speech into text, and the text is then be displayed in the input data window 310. Hence, the text displayed in input data window 310 may represent unstructured or unprocessed natural language text that has been input by the user 110 in some manner.

It should be recognized that other types of input devices 128 (e.g., keyboard, mouse, still camera, video camera, scanner, etc.) may be utilized by the user 110 to input the data in the input data window 310. Regardless of which type of input device 128 is utilized, the data from any of these input devices 128 may be converted to text and displayed in input data window 310.

The progress note window 320 is located on the opposite side of the interface 340. The progress note window 320 includes a structured format that defines a progress note document. In certain embodiments, the structured format may be populated with attributes associated with one or more templates 262 stored in a database 260 (e.g., templates associated with particular symptoms or illnesses). These templates 262 can expedite the generation of the document by supplying the user 110 with a listing of factors or attributes, e.g., which may be relevant to a particular illness, condition or symptom of a patient, that the medical practitioner may consider in diagnosing or treating the patient. In addition to providing a listing of attributes, the templates 262 may also be useful for satisfying obligations imposed on medical practitioners by governmental agencies or insurance companies.

The structured format that is presented in the progress note window 320 may include a hierarchy of structured sections and/or attributes that can be altered. The exemplary progress note in FIG. 3A is organized into different sections including high-level sections such as patient information, objective data, subjective data, assessment, and plan. The patient information section includes attributes such as the patient's name, date of birth, medical provider, insurance provider, etc. The subjective data section may include attributes such as history of present illness (HPI) and medical history. The objective data section includes attributes for vitals, assessments and examination (which is further sub-divided into heart, lungs and abdomen). The assessment section will include a single attribute that indicates a diagnosis for a patient. The plan section includes attributes for treatment, procedure, and immunizations.

It should be noted that many attributes that are typically included in a progress note have been omitted from the progress note in FIG. 3A for purposes of simplicity. For example, a typical progress note may include a variety of additional attributes or fields in each of the sections (e.g., history of surgeries, chief complaints, prescribed medications, etc.). However, for the basis of this disclosure herein, these details are not necessary.

Notice that while the input data window 310 is populated with text based on input from the user 110, none of the attributes located in progress note window 320 have been assigned values. However, when the data transfer button 330 is activated (e.g., by clicking on the button with a mouse, reciting a command into a microphone, pressing a button on a remote control or joystick, etc.), the language processor 210 converts the unstructured data included in the input data window 310 to populate the attributes of the progress note document located in the progress note window 320.

The data transfer button 330 may be activated using a variety of different data transfer triggers. In certain embodiments, the user 110 may trigger the data transfer button 330 by providing input via an input device 128 (e.g., clicking on the data activation button 330 or inputting a voice command into a microphone). In other embodiments, the data transfer button 330 may not be included on the interface 305. Rather, the a data transfer trigger may automatically be implemented in timely intervals (e.g., every minute or few minute), or automatically activated after a predetermined amount of data has been entered into the input section 310 on the interface 305. Regardless of whether or not a data transfer button 330 is included on the interface 305, any type data transfer trigger (e.g., whether provided via explicit input by the user or whether automatically triggered based on certain criteria) may serve to initiate a process for transferring data to the progress note window 320 or section of the interface associated with a structured format.

Thus, before the attributes in the progress note window 320 are populated, the unstructured text included in input data window 310 may be transmitted to the server 140 (as indicated by the arrow pointing from the input data window 310 to the server 120) and processed by the language processor 212. The resulting processed data is then returned by the server 120 to the client device 110 for display in the progress note window 320 (as indicated by the arrow pointing from the server 120 to the progress note window 320). FIG. 3B illustrates the interface 305 after the data from the input data window 310 has been processed by the language processor 212 and the attributes in the progress note window 320 have been updated accordingly.

A major advantage provided by the configuration of the interface 305 and its underlying functionality is that document generation is made simple and transparent to the user. This is accomplished, at least in part, by collecting all of the user input in a single interface element (i.e., the input data window 310) and intelligently converting the information into a medical document with a single activation (e.g., a single-click or single voice command) of the data transfer button 330. In contrast to many prior art systems, the user 110 is required to navigate through a series of interfaces and enter the information into a variety of different input elements in order to create a medical document. This can be tedious and time-consuming, and further requires the user 110 to have extensive experience with the software in order to navigate the interfaces properly. Thus, one of the inventive aspects associated with the disclosure herein relates to overcoming this problem by providing a single window to collect all of the user's input, and transferring the data into a structured format that can be rendered as a medical document (e.g., progress note) upon a single activation of the data transfer button 330.

In order to transfer the unstructured data into a structured medical document, the language processor 212 and corresponding sub-components, namely the grammar learning module 214 and intrinsic data identifier 216, may be utilized to “intelligently” process the unstructured data. These intelligent processing operations, which are described throughout this disclosure, permit the generation of the medical document in a single-click (or other type of single activation) and do not require the user to provide any additional input besides the data that is included in the data input window 310.

Amongst other things, the language processor 212 may utilize keywords input by the user 110 in order to determine which attributes should be associated with the data. For example, notice that the user 110 explicitly recited keywords (or phrases) such as “History of Present Illness”, “Examination”, “Heart”, “Lungs”, “Abdomen” and “Assessment”. These keywords directly correspond to the attributes in the progress note document. Thus, the language processor 212 can identify the presence of these keywords (and other keywords that are included in a predefined vocabulary) and associate the data that immediately follows the keywords with the corresponding attribute in the progress note document.

It should be noted that certain identifiers may be utilized to determine whether a mapping operation should be executed. For example, the mere fact that the term “heart” appears on in the input data window 310 should not automatically trigger the language processor 210 to map the data which immediately follows with the “heart” attribute under the “examination” category in the progress note window 320. Rather, the data following the word “heart” should only be mapped to the “heart” attribute in the progress note if certain mapping qualifications are satisfied (e.g., the word heart is followed by a colon or by a verb and certain pattern).

For example, consider the case where a keyword followed by a colon (i.e., “:”) represents a mapping qualification that instructs the language processor 212 that a mapping should be initiated between the information following the colon and the attribute associated with the keyword. If the user is typing the input provided in the input data window 310, the user may simply type the colon after the word “heart” in order to trigger the mapping by the language processor 212. However, in the case that the user 110 is speaking into a microphone and a speech recognition application is being utilized to populate the input data window 310 with text, a macro associated with the speech recognition application may automatically place a colon after a keyword, or any word for that matter, in response to a particular user action (e.g., in response to the user pausing for a predetermined amount of time after stating a keyword, or in response to the user stating the term “colon”).

The language processor 212 may utilize a grammar learning module 214 in order to edit the vocabulary of keywords or to edit the mapping qualifications. The grammar learning module 214 permits users to map new keywords (which are not already part of the existing vocabulary recognized by the language processor 212) to attributes in the progress note or electronic medical document, and to delete keywords from the existing vocabulary.

For example, as explained above, the language processor 212 may recognize that data in the input data window 310 immediately following the string “abdomen:” should be included in the abdomen field in the progress report. However, suppose the user 110 would prefer to recite (or type) the word “stomach” as an alternative to using the term “abdomen”, and still have the “abdomen” field in the progress note populated with the information that follows. In this case, grammar learning module 214 permits the user 110 to map the term “stomach” to the “abdomen” field in the progress note. In certain embodiments, the user 110 may do this by selecting an option (e.g., “Add to Vocabulary”) from a menu 370 located on the interface 305 or from a menu which is presented after right-clicking on the attribute in the progress note window 320, and specifying (e.g., by speaking or typing) a new word or phrase that is to be associated with the attribute. Once the new keyword (or phrase) is mapped to the attribute, the language processor 212 can identify the keyword in the unstructured text from the data input window 310 and associate the data immediately following the keyword with the selected attribute. In this manner, the language processor 212 is able to learn new ways to map the text in the data input window 310 to the progress note document in the progress note window 320.

FIG. 4 illustrates an exemplary method 400 for generating a document in accordance with certain embodiments of the present principles. The method 400 of FIG. 400 may be executed by the document generator 210. The method 400 begins at the start block and proceeds to step 410 which involves receiving data associated with a medical document from a user device 128 in a first window (e.g., the data input window 310). The data received from the user 110 may be characterized as unstructured textual data in the sense that it is not associated with a structured format, mapped to a set of attributes or the like. As explained above, a variety of different input devices 128 may be utilized to input the data to the first window.

After the data is received, the user 110 may initiate a transfer of the data to a second window on the interface by issuing a data transfer command (step 420). In the case that a user 110 is generating a progress note, the second window may represent a progress note window 320 similar to that which is illustrated in FIGS. 3A-3D. However, if the user 110 is generating a different type of document, an alternate window may be presented (e.g., a billing form window, prescription form window, test results window, etc.) that includes a structured format having different attributes or fields. The particular attributes or fields included in the window may be varied based on the particular type of document which is being created.

The user 110 may issue a data transfer command by clicking on the data transfer button 330 or by reciting predetermined voice activation command (e.g., “transfer data” or “generate document”). In certain embodiments, the document generator 210 resides a remote server 210 which receives the data from the first window after the data transfer command is issued. In another embodiment, the document generator 210 resides on the client device 120 and input from the from the first window is processed locally.

After the data transfer command is issued, the document generator 310 may map the data from the input data window 310 to the attributes associated with the structured format in the second window (step 430). Mapping the information to the attributes may include tagging the data in the first window with the attributes in the structured format, and populating the values of the attributes with the data. As explained above, this may be performed in part by utilizing keywords and mapping information learned from the grammar learning module 214. This may also include mapping operations performed by the intrinsic data identifier 216 which are described in further detail below.

Once the mapping operations have been performed, the data that was mapped to the attributes may be displayed in the second window in accordance with the structured format (step 430), e.g., as shown in FIG. 3B. If the mapping is being performed by a remotely located server 120, either the mapping information or the actual document incorporating the mapping information may be transmitted back to the client device 110 before being rendered on the display device 122. Then method 400 then terminates at the end block.

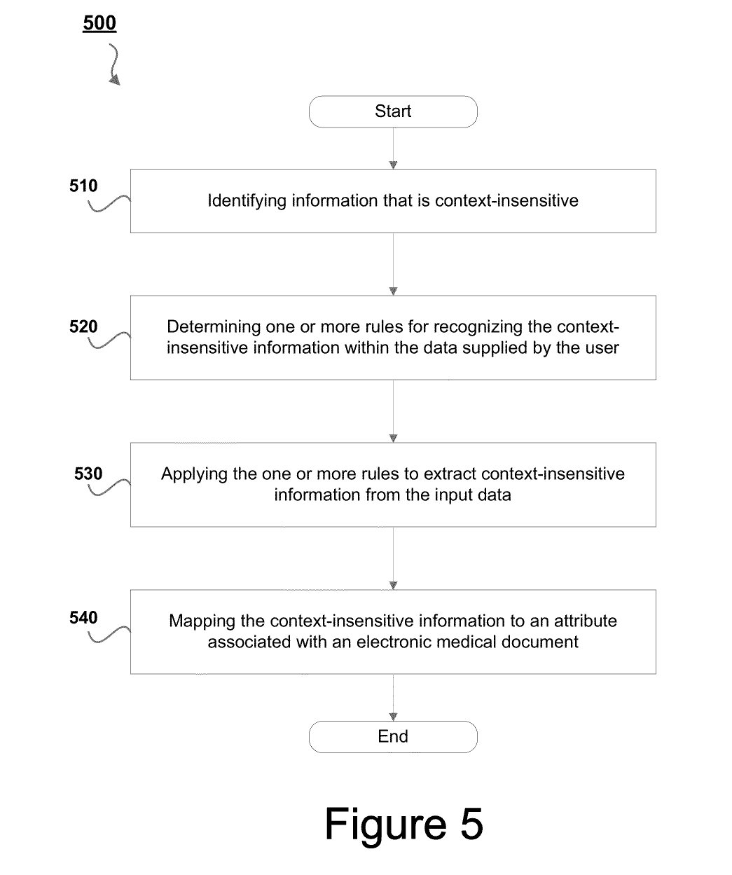

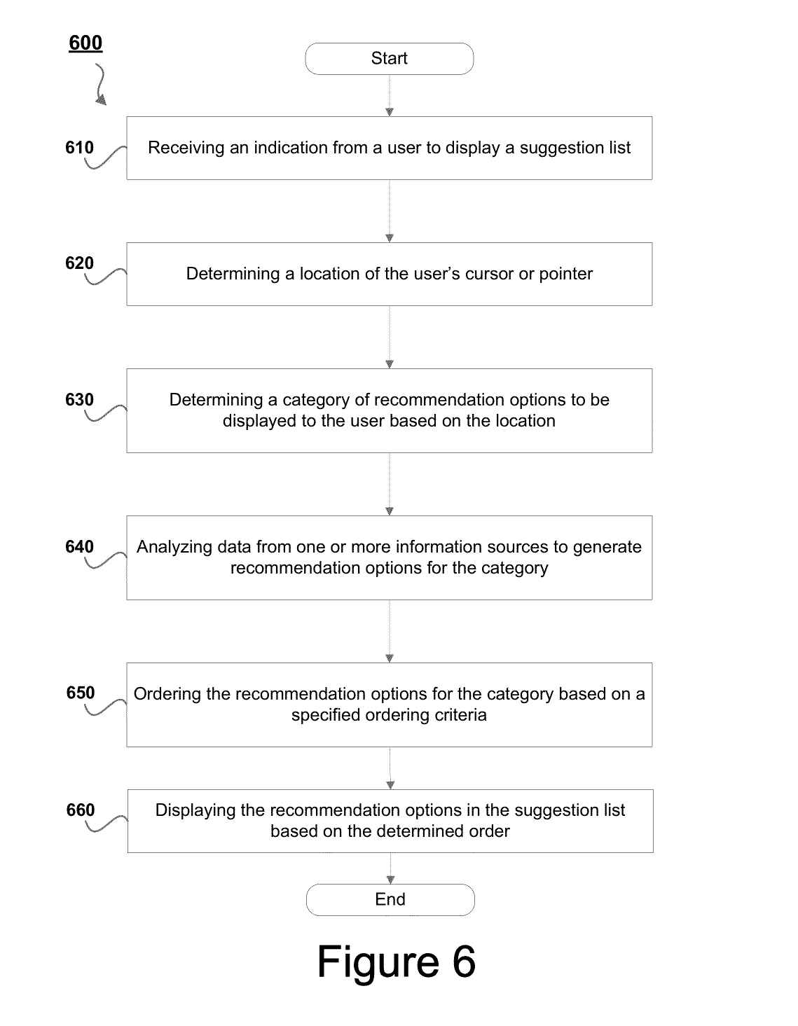

It should be noted that the order in which the of steps in FIG. 4 (as well as in FIGS. 5 and 6) are performed may vary where appropriate in accordance with different embodiments. For example, in certain embodiments the “mapping” step may be performed locally on the client before the data transfer button 330 is activated. In other embodiments, the “mapping” step may be performed remotely on the server after the data transfer button 330 is activated. Other types of changes are also contemplated with respect to the ordering of the steps in FIGS. 4-6.

As mentioned briefly above, the intrinsic data identifier 216 may be configured to provide alternative or supplementary support for mapping data to the progress note window 320. For example, the intrinsic data identifier 216 may be configured to recognize information in the data input window 210 that has an underlying inherent or fundamental meaning, and associate that information with particular attributes or sections of an electronic medical document. Unlike the mapping discussed above, the intrinsic data identifier 216 is able to map information in the data input window 310 to attributes in an electronic medical document regardless of where the information is located in the data input window 310 and regardless of the surrounding context (e.g., regardless of whether the information occurs after a colon or after a particular keyword). This type of information that can be recognized in any context may be referred to herein as “context-insensitive information” or “context-insensitive data”.

To illustrate an exemplary manner in which the intrinsic data identifier 216 may be utilized to generate an electronic medical document, consider the exemplary interface illustrated in FIG. 3B once again. Notice that the user 110 in this example provided input regarding the patient's blood pressure (i.e., “Blood pressure is 130/85.”) after the keyword “History of Present Illness”. However, after the user 110 activated the data transfer button 330, the progress note located in progress note window 320 populated both the “HPI” and “Vitals” attributes with this information. Thus, although the user 110 did not explicitly associate or map the blood pressure information with the “Vitals” attribute (e.g., by stating “Vitals” and then providing a colon), the intrinsic data identifier 216 applied deductive processing operations on the data in order to determine that it was appropriate to map the blood pressure information to the “Vitals” attribute in the progress note window 320.

In mapping the blood pressure information to the “Vitals” attribute without any explicit structure or use of keywords in the input text, the intrinsic data identifier 216 was able to intelligently discern that certain information, regardless of where it is found it the input provided by the user 110, should be mapped to particular elements in the electronic medical document because of the inherent or intrinsic nature of the information. Hence, it shouldn't matter which keyword or attribute the user has attempted to associate with this type of context-insensitive information, if the plain and objective meaning of the information does not change when it is presented in alternative contexts. Referring back to the example just described, the input specifying a patient's blood pressure does not change depending on the context in which the information is being presented. Thus, regardless of which keyword this information occurs after or is associated with, the meaning of the information remains the same.

Other examples of information which may have inherent or intrinsic meaning include information that specifies a patient's height, weight, pulse or heart rate, body temperature, respiratory rate, age, name, birth date, etc. Regardless of where this type of context-insensitive information is found within the input provided by the user 110, the intrinsic data identifier 216 is able to map this information to the attributes in an electronic medical document (e.g., a progress note).

It should be recognized that the intrinsic data identifier 216 may recognize and map the context-insensitive information to attributes in a variety of different ways. For example, in accordance with certain embodiments, the intrinsic data identifier 216 applies regular expressions and/or searches for a predefined list of trigger words within the data associated with the data input window 310. The trigger words and regular expressions may utilized to detect the context-insensitive information in a variety of different ways.

Consider the above example in which the intrinsic data identifier 216 was able to correctly map the patient's blood pressure to the “Vitals” attribute in the progress note. In order to do so, the intrinsic data identifier 216 may initially perform a case-insensitive search for one or more trigger words that are associated with blood pressure, such “blood pressure”, “arterial pressure” or “bp”. The search my be provided on all of the data entered by the user, since the meaning of the information does not change depending upon where it is presented. Each time one of the trigger words is detected, the intrinsic data identifier 216 may apply a regular expression on the data surrounding the keyword (e.g., data that is located in the same sentence and/or sentence immediately following the trigger word). In this particular example, the regular expression may attempt to identify text patterns that may be representative of an actual patient's blood pressure. An exemplary regular expression may be able to identify two integer numbers separated by a slash “/” (e.g., “130/85”), two numbers separated by the word “over” (e.g., “130 over 85”), or two textual number strings that are separated by a slash or the term “over” (e.g., “one hundred and thirty/eighty five” or “one hundred and thirty over eighty five”). If a portion of the data in the data input window 310 matches the trigger word and/or regular expression, the intrinsic data identifier 216 may then extract the applicable portions of the data and map the data to the attributes in the progress note window 320.

The information may be reformatted by the intrinsic data identifier 216 before being incorporated into the progress note document. For example, if the input data window 310 displays the textual string “The patient's blood pressure is one hundred and thirty over eighty five”, the intrinsic data identifier 216 may reformat this information to “BP 180/35 mm Hg” before being incorporated into the progress note in progress note window 320. Converting information in the electronic medical documents into a standardized format has many advantages including permitting uniform processing of the data, decreasing processing time of data (since the data does not have to be converted), and allowing for interoperability with components throughout the system 100 or with external systems (e.g., when exporting medical records to an external EMR vendor or commercial application).

The reformatting operations (which may be not exclusive to the intrinsic data identifier but rather may be generally implemented by the document generator 210 or other component) may include converting natural language data to structured data and storing the structured data in a manner so that it can be utilized in various types of operations later on (e.g., reporting operations, querying operations or operations performed by the task executor 23). For example, a medical practitioner may state “patient is a nonsmoker”, “patient smokes two packs a day”, or provide some other type of smoking indication for the patients. This information may be converted or reformatted such that it can be queried and such that the system 200 can provide a response to the practitioner. For example, in response to a doctor's query “show me the percentage of patients who have never smoked”, the software may provide output (e.g., on a display or speaker) the response “45 percent of patients have never smoked”.

It should also be recognized that the grammar learning module 214 may be utilized to supplement or modify the list of trigger words, regular expressions, or other types of data utilized to identify context-insensitive information. Thus, the medical practitioner or other users 110 can train the system to recognize additional types of context-insensitive information.

FIG. 5 illustrates an exemplary method 500 that be executed by the intrinsic data identifier 216 to identify and map context-insensitive information to an electronic medical document. The method 500 begins at the start block. In step 510, information is identified that is context-insensitive by its very nature. In some cases, this may include statistical data, measurement data, test results, vitals information, or other types of information. In certain embodiments, the context-insensitive that is identified may be stored in a list.

For each separate piece of context-insensitive information that is identified, a corresponding set of one or more rules may be determined (step 520). For example, as exampled above, the rules for recognizing context-insensitive information may involve applying searches for trigger words or regular expression matches. Other types of rules may also be utilized. The rules may be associated and stored with the listing of context-insensitive information in a database 260.

The determined rules may applied to identify and extract context-insensitive information from the input provided by the user (step 530). After the context-insensitive information has been extracted from the input, the context-insensitive information may be mapped appropriate attributes associated with an electronic document (step 540). For example, if the intrinsic data identifier 216 extract context-insensitive information comprising a blood pressure reading, this information may then be mapped to the attributes associated with a patient's vitals. The mapping of the information may be based on predetermined set of known associations. The mapped information may be then be displayed in a window on an interface which is presented to the user, e.g., the progress note window. After the mapping is performed, the method 500 proceeds to the end block and terminates.

Another component that may assist the document generator 210 is the record retriever 218. The record retriever 218 may be configured to generate an electronic medical document or supplement the information included in an electronic medical document with prior patient data 264 (e.g., prior EMRs, prior forms filled out by the patient, a profile associated with the patient, etc.) stored in a database 260 on the server 120. For example, the record retriever 218 may be configured to analyze information that is included in one or more previously generated EMRs for a patient, extract the information from the previous EMRs, and incorporate that the extracted information into a new electronic document.

A patient's EMRs may include previous progress notes generated by medical practitioners, test results (e.g., results of blood tests, electrocardiogram tests, urines tests, etc.), images associated with imaging or scans (e.g., x-ray scans, computed tomography or CT scans, computed axial tomographs or CAT scans, etc.), and other types of medical documents. The record retriever 218 is able to analyze this information and incorporate this information into a new electronic medical document.

Consider the interface 305 in FIG. 3B once again. Notice that various attributes have been assigned values despite the fact that the input provided by the user 110 did not specify these values. For example, in the “Patient Info” section, the user 110 did not specify the patient's date of birth or insurance company. Likewise, in the “Subjective” section, nothing in the input data window 310 indicates that the user 110 previously had a heart attack or melanoma, yet the “Medical History” attribute has been assigned the values “heart attack, melanoma”. Rather, the record retriever 218 assigned values to these attributes by extracting information from patient data 264 that was already stored on the server 264.

In certain embodiments, the record retriever 218 may automatically incorporate this information into a medical document. In other embodiments, this information is incorporated into a new medical after the user 110 explicitly specifies that such should be included. In the case that the record retriever 218 relies on explicit requests from the user 110 before executing, the record retriever 218 may work in conjunction with the task executor 230 and/or the functionality of these components may overlap to some extent in performing certain actions (e.g., in performing certain actions associated with importing a patient's history). A further discussion of this is provided below in describing the operation of the task executor 230.

It should be noted that the record retriever 218 is not limited to incorporating textual information into an electronic medical document, and may be configured to incorporate any type of multimedia data (e.g., text, images, video, audio recordings, etc.) into a document. For example, in certain embodiments, the record retriever 218 may retrieve images associated with an x-ray scan, or other type of scan, from the patient's data 264 and incorporate this information into a progress note or other medical document. In other embodiments, possibly in scenarios where the electronic document is not likely to be printed, the record retriever 218 may incorporate audio recordings or video recordings into a document, or may incorporate links (e.g., HTML hyperlinks) to multimedia data in the document.

Moving on, the suggestion generator 220 is another useful sub-component of the document generator 210. The suggestion generator 220 many be configured to provide recommendations or suggestions to the user 110 for populating the attributes of an electronic document. For example, in the case that a user is generating a progress note, the suggestion generator 220 may recommend assessments, treatments, tests that should be performed on a patient, surgeries, procedures, etc. (Note: the term “treatment” is used throughout this disclosure in a broad sense to encompass various concepts associated with treating a patient such as prescriptions, laboratory tests, diagnostic imaging, patient care or the like.) The recommendations provided by the suggestion generator 220 may be derived from various sources of information as described in further detail below.

The type of recommendations that are provided by the suggestion generator 220 may depend upon where the user's cursor or pointer (e.g., a mouse pointer) is located. For example, if the user's 110 pointer or cursor is located near a section of the input data window 310 associated with the keyword “Prescriptions:”, then a list of recommended drugs may be presented to the user 110. Alternatively, if the user's cursor or pointer is located near the section of the input data window 310 associated with the keyword “Surgeries:”, then a list of recommended surgeries may be presented to the user 110.

The presentation of the recommendations (e.g., the order in which the recommendations are displayed) may also be varied based upon a likelihood or probability that the particular recommendation is accurate. The manner in which the likelihood or probability is determined may vary as explained in further detail below. In certain embodiments, the likelihood or probability is based on an analysis of an aggregate pool of patient data 264 (e.g., patient EMRs).

In certain embodiments, a user may activate the suggestion generator 220 by right-clicking on an area in either the input data window 310 or progress note window 320. In another embodiment, various sections of the input data window 310 and/or progress note window 320 may include a drop down element (e.g., an HTML drop down menu) that lists the recommendations provided by the suggestion generator 220. In an even further embodiment, the suggestion generator 220 may be accessed via a menu 370 located on the interface 305.

To illustrate the concept embodied by the suggestion generator 220, consider the exemplary interface 305 disclosed in FIG. 3C. As shown therein, a list of suggestions 380 is displayed to the user 110 after activating (e.g., right-clicking) the suggestion generator 220. The recommendations may be accompanied with corresponding insurance codes (e.g., “531” and “023”). In the exemplary interface disclosed in FIG. 3C, the user's cursor (e.g., the last place where text was typed by the user 110) is located after the keyword “Assessment:”. Therefore, the suggestion generator 220 recommends a list of assessments to the user. If the cursor was located after a different keyword such as “Prescriptions:”, the suggestion generator 220 may then recommend a list of drugs to the user 110 that could be prescribed to the patient.

The suggestion generator 220 may determine the contents of the suggestion list 380 by analyzing information from different sources including information input by the user 110 in input data window 310, information included in the patient's prior medical records or profile, or information included in an aggregated pool of all patient data 264 which is stored on the server 120 (i.e., a collective repository of data for all patients who have medical records stored on the server 112). The information from these sources may be combined in any manner to populate the contents of the suggestion list 380. Examples of how these information sources may be utilized by the suggestion generator 220 are described below.

Suppose a user 110 desired recommendations for diagnosing a patient's illness. To accomplish this, the suggestion generator 220 may analyze the data input by the user 110 in the input data window 310 to ascertain symptoms of the patient's present illness or condition. This may include analyzing the data that is associated with, or which follows, the keyword “History of Present Illness”. After identifying the symptoms of the patient based on this analysis, the symptoms may be correlated with a variety of common assessments or diagnoses (e.g., by querying a database containing correlations between symptoms and illnesses). The results may be presented in the recommendation list 380.

In another embodiment, the suggestion generator 220 may utilize an aggregated pool of information comprising all of the patient data 264 stored on the server. For example, after determining the symptoms of a patient, the suggestion generator 220 may analyze the records of all patients having records on the server 120 to determine how other patients having similar symptoms had been diagnosed. The suggestion list 380 can then be populated with this information.

Also, as mentioned above, the patient's own prior medical history or other patient data 264 may be utilized in populating the contents of the suggestion list 380. For example, suppose that a user 110 desires recommendations for prescribing a drug. A potential list of recommended options can be generated as described above (e.g., by correlating information in a database with known associations or by analyzing an aggregate pool of patient data 264). However, the information specific to the patient can be utilized to refine, alter or reorder this list. For example, if the patient's own medical history indicates that that the patient is allergic to one of the drugs that is commonly recommended for a particular illness, this drug may be taken off the suggestion list 380 or highlighted in some manner (e.g., may be highlighted in red or with an exclamation mark to indicate to the doctor that there may be risks associated with recommending that particular drug).

The particular ordering of recommendation options in the suggestion list 380 may vary. In the case that the recommended options are derived from an aggregate pool of patient data 264, the ordering of the recommended options in the suggestion list 380 may be based on the number of records having a detected association. For example, in that case that that the suggestion generator 220 is generating a list of drugs for recommending a prescription to a patient, the suggestion generator 220 may search the aggregated patient data 264 to determine which drugs have been prescribed to other patients who experienced similar symptoms or who were diagnosed with the same illness or condition. The drugs that were most commonly prescribed to patients having the particular symptoms, or having been diagnosed with a particular illness, may appear at the top of the list. On the other hand, the drugs that were not commonly prescribed may be included lower on the list or excluded form the list altogether. Other types of schemes may also be employed with respect to ordering the items presented on the recommendation list 280.

It should be noted that the recommendations may be presented to the user 110 before or after the user has activated the data transfer button 330. If the recommendations are provided after the button 330 is activated, the user 110 can select a recommendation from the list to be incorporated into the input data window 310 and then re-activate the data transfer button 330 in order to update the information in the progress note window.

In addition, the recommendations presented to the user 110 are not required to be presented in the input data box 310. In some embodiments, the suggestion generator 220 may provide a list of recommendations in the progress note window 320 (or other portion of the interface 305) as well, or in both windows. If the recommendations are provided in the progress note window 320, the list of recommendations may once again vary depending upon where the user's 110 cursor or pointing device is placed (e.g., if the pointer is located near the prescriptions attribute in the progress note window 320, the suggestion generator 220 may provide a list of recommend drugs to prescribe to the patient).

FIG. 6 discloses an exemplary method 600 for generating a suggestion list in accordance with certain embodiments of the principles disclosed herein. The method 600 may be executed by the suggestion generator 220. The method 600 begins in the start block and proceeds to step 610 in which an indication is received from a user to display a suggestion list. As explained above, the indication may be provided by right-clicking on a portion of the interface 305, or by selecting a drop-down menu.

The location of the user's cursor or pointing device is determined at the time that the indication is received (step 620). The location of the user's cursor or pointing device is used to determine a category of recommendation options that will be displayed to the user 110 on the interface 305 (step 630). For example, if the location is determined to be in the vicinity location near the keyword “Assessment” (or in the vicinity of the “Assessment” attribute in the case that the determined location is in the progress note window 320 and not the input data window 310), the recommendation options may be populated with recommendations for diagnosing a patient.

Before populating the suggestion list 380 with one or more recommendation options, the suggestion generator 220 analyzes the data from one or more information sources (step 640). The information source that is analyzed may include one or more of the following: data input by the user, data included in the patient's prior medical records or profile, or data included in an aggregated pool of all patient data. The data from these sources may be utilized to generate the list of recommendation options.

After the list of recommendation options is complied, the recommendation options are ordered based on some ordering criteria (step 650). The ordering criteria may vary in different embodiments. In certain embodiments, the ordering criteria is based on the number detected correlations found in the aggregate patient data 264 as explained above.

Before the method proceeds to the end block and terminates, the recommendation options are displayed on the interface within the suggestion list 280 based on the determine order.

Like the suggestion generator 220, the feedback indicator 222 also provides a feedback to the user 110 to assist the user 110 in generating an electronic medical document. The particular feedback provided by the feedback indicator 222 specifies the sections or attributes of the electronic medical document that have been completed, or at least addressed to some extent, by the user 110. This feature may be particularly useful when dealing with documents, such as progress notes, that typically include a very large number of attributes.

FIG. 3A illustrates an exemplary embodiment of the feedback indicator 222. As shown therein, the feedback indicator 222 is presented as an element that overlays the progress note window 320. In certain embodiments, the user 110 may be permitted to move or reposition the feedback indicator 222 to another location on the interface 305. As explained above, FIG. 3A illustrates an interface 305 that may be displayed before a user 110 activates the data transfer button 330 to populate the progress note window 320. Thus, since none of the sections or attributes in the progress note window have been populated, the feedback indicator 222 remains empty.

However, after the user 110 activates the data transfer button 330, the feedback indicator 222 is populated with the attributes and/or document sections that have been filled out. In the example illustrated by FIG. 3B, the list is populated with the values “HPI”, “Vitals”, “Assessment”, “Examination” and “Medical History”. In other embodiments, the list may also display sub-attributes, such as “Heart” and “Lungs”, which were populated, or include the names of the sections that have been fully completed (e.g., if every item in the “Subjective” data section was assigned a value, the section may be included in the feedback indicator 222). If the user continues to provide further input, the list may be expand or become scrollable.

Moving on to FIG. 3D, an interface 305 is disclosed which demonstrates the operation of the input highlighter 224 in accordance with certain embodiments. The input highlighter 224 provides feedback to the user 110 as the user is providing input to input data window 310 (e.g., dictating or typing the input). Specifically, the input highlighter 224 provides feedback to the user that indicates the portions of the input which are being utilized to populate the progress note window 320.

Using the example illustrated in FIG. 3D, the information which is underlined represents the information that is being utilized to populate the attributes in the progress note window 320, while the information which is not underlined is not being utilized to populate the progress note window 320. In this case, there are only two pieces of information that are not being utilized to populate the document in the progress note window 320 (i.e., the information which recites “Mr. Jones is a nice man who is one of my favorite patients” and “Mr. Jones appeared very tired today”).

There may be multiple reasons that information is not being utilized to generate a medical document. For example, information provided in the input data window 310 may be ignored if the information is irrelevant (e.g., the information “Mr. Jones is a nice man who is one of my favorite patients” is not pertinent to any of the attributes associated with a progress note). The information may also be ignored if the information was not entered correctly (e.g., the user misspelled a word when typing or the speech recognition system did not accurately transcribe the user's input) or if the document generator 210 was not able to discern the meaning of the input (e.g., the information was relevant but it was stated in a manner that was recognized by the document generator 210).

Regardless of the reason that a particular piece of input was ignored, the input highlighter 224 still serves a useful role in that it alerts the user 110 that a particular piece of information may be ignored. This allows the user 110 to restate or renter the information at a later time if it is important, possibly using different terms, or possibly after the grammar learning module 214 is utilized to supplement the knowledge of the document generator 210.

It should noted that other types of indicators (i.e., other than underlining) may be used to indicate that a portion of input is being utilized to generate an electronic document such as a progress note. Exemplary indicators may be include text highlighting (e.g., where the color behind the text is altered), bolded text, italicized text, colored text, etc. In addition, in certain embodiments, it should be realized that the input highlighter 224 may configured in an opposite manner in the sense that it only indicates or highlights the input that is not being utilized to populate the progress note window 320, and thus ignores the information that is being used to populate the progress note window 320.

In view of the above discussion, it should be apparent that the document generator 210 can assist a user 110 in creating medical documents in numerous ways and significantly reduce the amount of time required to generate a document. As discussed above, a user 110 may provide some basic input (with or without using keywords or other formatting indicators), and the system has the ability to intelligently generate a document using various sources of information after a single activation of a data transfer button 330. The system also provides a variety of features that provide feedback and assistance to the user 110 while generating the document (suggestion generator 220, feedback indicator 222 and input highlighter 224). In addition, a user 110 may supplement the intelligence of the system through training or learning mechanisms (e.g., via the functions executed by the grammar learning module 214).

When this type of background intelligent processing is combined with a simplified interface (e.g., similar to those illustrated in FIGS. 3A-3D) that is organized in a manner which makes the operation of the software transparent to the user 110, this results in a powerful, user-friendly system that permits a user 110 having little or no prior experience with the software to efficiently generate documents. In doing so, the document generator 210 permits medical practitioners to be more productive, see additional patients and earn additional revenue, while ensuring compliance with regulations and/or obligations imposed by governmental agencies and insurance companies (e.g., by utilizing the templates 262 to ensure that such regulations or requirements are satisfied).

As explained above, the document creation techniques taught herein are merely used to illustrate examples of how the present principles can be embodied and should not be construed as limiting in manner. Numerous variations may be implemented without departing from the present principles. For example, although the interfaces in FIGS. 3A-3D where describing primarily in the context of generating a progress note, it should be recognized that nearly any type of document can be generated using similar principles (whether or not the document relates to the medical field).

In addition to the above discussion, the principles described herein also extend to useful actions or commands that may be implemented by the system to assist a user 110 with additional types of medical services. These additional actions serve various purposes and may differ in several respects. Some of these useful actions include operations that can assist the document generator 210 in creating a document. Other actions include operations that may be performed on documents that have already been created (e.g., documents that have been generated utilizing the document generator 210). Each of the actions discussed herein may be implemented or performed the task executor 230 illustrated in FIG. 2. Note, that while the task executor 230 be illustrated as an entity that is separate and distinct from the document generator 210, the functionality of these components may overlap to some extent, and these two components may represent a single unitary component in some embodiments.

In certain embodiments, the task executor 230 is configured to execute the following actions: (1) import all history associated with a patient, (2) import a subset of history associated with a patient, (3) send a fax, (4) verify patient data, (5) list order sets, (6) list templates, (7) add CPT code and (8) add E&M code. Each of these actions is discussed in further detail below.

It should be noted that the list of actions provided above is not meant to be exhaustive. To the contrary, the task executor 230 may be configured to implement a comprehensive set of user friendly, natural language commands that can map to nearly any and all possible actions that may be performed on any EMR software. For example, in certain embodiments, the task executor 230 may be configured to verify the existence of any attribute in a patient's EMRs (e.g., verify a patient's medical history, vitals, age, insurance provider, etc.), import any type of data or attribute to a document that is being generated or updated (e.g., import family medical history, current medication, insurance provider information, etc.), or perform reporting operations that consider the aggregated data of all patients (e.g., report all patients that smoke, report the percentage of patients that received flu shots in 2012, report all patients that have some form of cancer, etc.). The task executor 230 may further be configured to execute actions such as “show me directions from my office to patient John Smith's house” or “create reminder at . . . ”, Hence, nearly any type of action associated with EMR software may be performed by the task executor 230.

Before addressing the specifics of the above commands, it is pointed out that a user 110 may activate these commands in different ways. In certain embodiments, the user 110 activates these actions by clicking on an element display on an interface (e.g., by clicking on the command display button 350 illustrated in the exemplary interfaces 305 shown in FIGS. 3A-3D). In other embodiments, the actions are initiated by voice commands input by the user. In other embodiments, these actions may be automatically executed without explicit input from the user (e.g., as mentioned above, the record retriever 218 may automatically import a patient's history when generating a document). Other ways of activating the actions are also contemplated.

The task executor 230 may execute the “import all history” and “import a subset of history” in the same or similar manner to that which was mentioned above in describing the record retriever 218. In the case that the “import all history” action is initiated, the task executor 230 may search all the electronic documents in the patient data 264 that are associated with a patient to populate the fields of a document that is being generated by the user 110. Any attribute in the document can be assigned a value, or supplemented, with the information from the subset of the patient data 264 that is specific to the patient.

For example, suppose a progress note was being generated by the user 110 which included attributes for associated with patient's family medical history and previous surgeries performed on the patient, and further suppose that the patient's prior EMRs included information about the patient's family medical history and previous surgeries that was not included in the progress note being generated. If the “import all history” action was triggered, the task executor 230 may extract the relevant information from the patient's previous electronic medical records and utilize this information to populate the attributes of the progress note.

Alternatively, the user 110 may select the “import a subset of history” action to specify that only a subset of the attributes in an electronic document should be updated if there is supplemental information included in the patient's EMRs which is relevant. In this case, the task executor 230 may only search particular attributes in the patient's EMRs to determine whether supplemental information exists. For example, if the user 110 only desired to import the information regarding a patient's allergies, the task executor 230 would only search fields that may contain allergy information and would only update the attribute in the progress note pertaining to “allergies”.

As explained above, the task executor 230 may also be configured to send a facsimile transmission if the “send a fax” action is selected by the user 110. Faxes may be sent for a variety of reasons and to a variety of different entities. For example, a fax may be sent to a medical provider if user 110 is working in conjunction with the medical provider to treat a patient, or to transfer a patient's medical record to a new provider. In other embodiments, faxes may be sent to pharmacies (e.g., to order prescriptions) or to insurance providers.

The task executor 230 includes several useful features that assist the user in transmitting a fax. One useful aspect relates to the fact that the task executor 230 does not require the user 110 to populate the fields associated with sending a fax (e.g., the fax number field or fields on a fax cover sheet that include the name of person or entity receiving the fax, subject line, total number of pages being faxed, etc.). Rather, the task executor 230 may retrieve this information from profiles stored in a database 260 or from the actual document which is being faxed. The task executor 230 may automatically populate the appropriate fields with the retrieved information.

For example, suppose a user 115 has just finished creating a progress note and wishes to fax the document to another medical provider. The user may simply specify the recipient (e.g., by reciting a command into a microphone such as “fax document to John Smith, MD” or by selecting a recipient from a menu) and all of the fax information (e.g., fax number, subject line, etc.) will be retrieved from the database 264. The task executor 230 may then utilize the retrieved information to populate the appropriate fields for sending the fax and filling in the fields applicable to the cover sheet. Information from the document which is being faxed may also be utilized to populate fields (e.g., the subject line of the fax cover sheet may be state “Progress Note for Patient Jane Doe” or the variable which indicates the “Total Number of Pages Being Faxed” may be populated after analyzing the length of the document).

In accordance with certain embodiments, the task executor 230 may execute a timer before sending the fax. For example, after the user 110 initiates a command for sending a fax, the task executor 230 automatically populates the fax fields and uses a timer to execute a ten second countdown (or other predetermined time period). If the timer expires after the ten seconds, the fax is automatically sent to the specified recipient. Utilizing the timer to automatically send a fax further builds upon the concept of simplifying the user experience and streamlining the functioning of tasks.

However, if the user does not want the fax to be sent at the expiration of the timer (e.g., because the user 110 wishes to supplement or modify the information on the fax cover sheet), then the user may provide some simple indication (e.g., by clicking anywhere on the interface or clicking on a “Stop” button) and the timer will disappear.

Moving on, the “verify data patient data” is another action that may be implemented by the task executor 230. This action permits a user 115 to verify any piece of information included in the patient data 264 (e.g., patient's history, current medications, family history, dates of previous doctor visits, birthdate, hospitalization record, etc.). This may involve searching the patient's records (or a database or file summarizing the information included in all of the patient's records) for the relevant piece of information and reporting the findings to the user 110.

For example, a user 115 may state “verify allergies” or “verify allergies for Mike Johnson” (or utilize other means of inputting the command such as typing) in order to determine the allergies associated with a particular patient. In response to receiving the user input, the task executor 230 may analyze the patient's previous medical records to determine whether any of the records indicate that the patient is allergic to a particular drug or other substance. Suppose the task executor 230 detected two relevant records: one indicating that the patient receives allergy shots on a weekly basis because the patient is allergic to pollen, and the other record indicating that the patient is allergic to penicillin. In this case, the task executor 230 would extract the relevant information from both of these records and provide feedback (e.g., by outputting audio via a speaker or outputting text or a screen) to the user 110 reporting the detected allergies. The task executor 230 may also display the actual records that included the information and/or links to the records on the interface that is displayed to the user 110.

The task executor 230 may further be configured to implement the “list order sets” action. Generally speaking, an “order set” refers to a predefined grouping of orders (e.g., which may include medications or items used for treatment) that are associated with a particular condition, disease, or procedure. If the task executor 230 receives a request to execute a “list order set” action, the task executor 230 may initially analyze the assessment data or symptom data of the patient (e.g., by analyzing values of the “assessment” or “HPI” attributes in a progress note). Based on this analysis, the task executor 230 may then provide feedback to the user indicating a list of order sets that the user 110 is likely to select. This may involve querying a database 260 that includes information which correlates order sets with the assessment info or symptom info. Alternatively, this may involve querying an aggregate pool of patient data 264 to determine which order sets had been administered to other patients who had similar symptoms or who had a similar illness. After a list of order sets is displayed, the user 110 can select an order set in order to incorporate the order set information into a document (e.g., a progress note) or to actually submit a purchase order for the order set.

Another action which may be executed by the task executor 230 is the “list templates” action. In general, a medical template 262 includes a checklist of common factors, indicators, or procedures a doctor should investigate when dealing with particular symptoms, illnesses or conditions. The task executor 262 provides a listing of available templates to users 110 and permits users to incorporate the templates 262 in medical documents (e.g., progress notes).

In the case that symptom data or assessment data is available to the task executor 230, the task executor 230 may display a subset of the available templates which are relevant to the particular symptom data or assessment data since it is likely that the medical practitioner more likely to select such templates.

The “add CPT code” and “add E&M code” represent operations that carried out by the task executor 230 to facilitate the processing of insurance claims. A CPT code (or Current Procedural Terminology code) generally represents a code that describes medical, surgical, and diagnostic services that are rendered to a patient, while an E&M code (Evaluation and Management code) is a code associated with billing processes for medical practitioners. These codes may be utilized by practitioners in order to be reimbursed for an encounter with a patient (e.g., by Medicare, Medicaid programs, or private insurance). Thus, the task executor may respond to an “add CPT code” or “add E&M code” command by incorporating a corresponding code into a document that is being generated or updated.

As explained above, the list of actions or commands discussed in this disclosure are not meant to be exhaustive. Any number of operations can be incorporated into the action set that is implemented by the task executor 230. This includes any operation that is able to verify the existence of data in a patient's profile, add data to a document that is being generated or updated, or perform operations that consider the aggregated data of all patients or a subset of patients which may be filtered according to certain specified or selectable criteria. This also includes operations that implement tasks after a document has been created (e.g., faxing a document, preparing a prescription, etc.) or other types of tasks that are useful to a medical practitioner.

While there have shown and described and pointed out various novel features of the invention as applied to particular embodiments thereof, it will be understood that various omissions and substitutions and changes in the form and details of the systems and methods described and illustrated, may be made by those skilled in the art without departing from the spirit of the invention. Amongst other things, the steps shown in the methods may be carried out in a different orders in many cases. Those skilled in the art will recognize, based on the above disclosure and an understanding therefrom of the teachings of the invention, that the particular hardware and devices that are part of the medical system described herein, and the general functionality provided by and incorporated therein, may vary in different embodiments of the invention. Accordingly, the particular system components shown in FIGS. 1-6 are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation, and the present invention is limited only by the claims which follow.

What is claimed is:

1. A method for providing a medical service, comprising:
receiving a user input in a first section on an interface comprising unstructured textual data that is associated with an electronic medical record, wherein the user input received in the first section is utilized to update the electronic medical record without requiring the user to provide an additional second input in a separate section, said unstructured textual data being stored on a non-transitory computer storage medium;
mapping, with a processor, at least a portion of the unstructured textual data to one or more attributes associated with a structured format for the electronic medical record; and
in response to receiving a single data transfer command, generating an instruction causing a transfer of the unstructured textual data to a second section on the interface associated with the structured format for the electronic medical record, wherein the mapped data is displayed in the second section in accordance with the structured format.

2. The method as recited in claim 1, further comprising:
identifying context-insensitive information in the unstructured textual data;
associating the context-insensitive information with one or more attributes of the structured format in accordance with said mapping without utilizing keywords in the unstructured textual data.

3. The method as recited in claim 1, further comprising:
displaying a suggestion list on the interface comprising one or more recommended options that are selectable to populate the attributes of the structured format.

4. The method as recited in claim 3, further comprising:
analyzing a pool of aggregate patient data to populate the suggestion list that is presented on the interface;
assigning probabilities to the recommended options based on the analysis of the aggregate patient data; and
determining an order for presenting the recommended options based on the assigned probabilities.

5. The method of claim 3, wherein the electronic medical record comprises a progress note and the recommended options associated with the suggestion list comprise one or more of assessment recommendations and prescription recommendations.

6. The method as recited in claim 1, further comprising:
providing a real-time feedback indication that indicates which portions of the unstructured textual data are being utilized to populate the one or more attributes of the structured format.

7. The method as recited in claim 1, further comprising:
after initiation of the data transfer command, providing a visual indication of the attributes in the structured format which have been assigned values.

8. The method as recited in claim 1, further comprising:
importing at least a portion of recorded data included in an electronic medical record that had been previously created to populate the attributes of the structured format in the second section.

9. The method as recited in claim 1, further comprising:
receiving and executing a querying command that performs an operation on data that has been mapped in accordance with the structured format.

10. A system for providing a medical service, comprising:
a display on which a first section is presented on an interface configured to receive a user input comprising unstructured textual data that is associated with an electronic medical record, wherein the user input received in the first section is utilized to update the electronic medical record without requiring the user to provide an additional second input in a separate section, the display being further configured to present a second section comprising a structured format associated with the electronic medical document, wherein a data transfer trigger is configured to generate an instruction that causes a transfer of the unstructured textual data to the second section in accordance with the structured format;
a processor configured to map at least a portion of the unstructured textual data to one or more attributes associated with the structured format in the second section; and
a non-transitory computer storage medium for storing the unstructured textual data.

11. The system as recited in claim 10, wherein the processor is further configured to:
to identify context-insensitive information in the unstructured textual data, and associate context-insensitive information with at least one attribute of the structured format in accordance with said mapping without utilizing keywords in the unstructured textual data.

12. The system as recited in claim 10, wherein the display is further configured to:
present a suggestion list on the interface comprising one or more recommended options that are selectable to populate the attributes of the structured format.

13. The system as recited in claim 12, wherein the processor is further configured to:
analyze a pool of aggregate patient data to populate the suggestion list that is presented on the interface;
assign probabilities to the recommended options based on the analysis of the aggregate patient data; and
determine an order for presenting the recommended options based on the assigned probabilities.

14. The system of claim 12, wherein the electronic medical record comprises a progress note and the recommended options associated with the suggestion list comprise one or more of assessment recommendations and treatment recommendations.

15. The system as recited in claim 10, wherein the processor is further configured to:
provide a real-time feedback indication that indicates which portions of the unstructured textual data are being utilized to populate the one or more attributes of the structured format.

16. The system as recited in claim 10, wherein the display is further configured to:
provide a visual indication of the attributes in the structured format which have been assigned values after generation of the data transfer instruction.

17. The system as recited in claim 10, wherein the processor is further configured to:
import at least a portion of recorded data included in an electronic medical record previously created to populate the attributes of the structured format in the second section.

18. The system as recited in claim 10, wherein the processor is further configured to:
receive and execute a querying command that performs an operation on data that has been mapped in accordance with the structured format.

19. A non-transitory computer storage medium comprising program instructions for providing a medical service, wherein the program instructions, when executed on a computer, cause the computer to:
receive a user input in a first section on an interface comprising unstructured textual data that is associated with an electronic medical record, wherein the user input received in the first section is utilized to update the electronic medical record without requiring the user to provide an additional second input in a separate section;
map, with a processor, at least a portion of the unstructured textual data to one or more attributes associated with a structured format for the electronic medical record; and
in response to receiving a single data transfer command, generate an instruction causing a transfer of the unstructured textual data to a second section on the interface associated with the structured format for the electronic medical record, wherein the mapped data is displayed in the second section in accordance with the structured format.

20. The computer storage medium as recited in claim 19, wherein the program instructions further cause the computer to:
identify context-insensitive information in the unstructured textual data; and
associate the context-insensitive information with one or more attributes of the structured format in accordance with said mapping without utilizing keywords in the unstructured textual data.
